(19) United States
(12) Patent Application Publication
(10) Pub. No.: US 2007/0230331 A1
(43) Pub. Date: Oct. 4, 2007

(54) Power line communication network and method

(75) Inventors: Joon-hee Lee, Gunpo-si (KR); Ju-han Lee, Suwon-si (KR); Jun-hae Choi, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/641,071

(22) Filed: Dec. 19, 2006

(30) Foreign Application Priority Data
Mar. 31, 2006 (KR) 2006-29810

(51) Int. Cl. H04J 3/14; H04Q 7/00

(52) U.S. Cl. 370/217; 370/331

(57) ABSTRACT

A power line communication (PLC) network and method, in which a coordinator can be changed. The PLC network includes a coordinator and a standby coordinator. The coordinator performs scheduling coordination in a PLC cell and periodically transmits scheduling information about the scheduling coordination to stations in the PLC cell. The standby coordinator serves as the new coordinator instead of the coordinator when the coordinator does not operate for a predetermined amount of time.

### CROSS-REFERENCE TO RELATED APPLICATIONS

This application claims the priority under 35 U.S.C. 119 §(a) of Korean Patent Application No. 10-2006-0029810, filed on Mar. 31, 2006, in the Korean Intellectual Property Office, the disclosure of which is incorporated herein in its entirety by reference.

### BACKGROUND OF THE INVENTION

1. Field of the Invention

The present general inventive concept relates to a power line communication (PLC) network system, and more particularly, to a system to designate and change a coordinator in PLC network, and a method thereof.

2. Description of the Related Art

A coordinator refers to a device that performs scheduling associated with medium access in a network. If a problem occurs and the coordinator and network scheduling cannot be performed, users cannot be provided with a normal service until the coordinator operates normally. Thus, in this case, another station in the network has to be able to serve as the coordinator.

Even when there is no problem with the coordinator, a station serving as a coordinator needs to have superior cell coordination capability.

### SUMMARY OF THE INVENTION

The present general inventive concept provides a power line communication (PLC) network capable of changing a coordinator to optimally perform network scheduling.

The present general inventive concept also provides a PLC method capable of changing a coordinator to optimally perform scheduling coordination in a cell of a PLC network and a computer-readable recording medium having recorded thereon a program to implement the PLC method.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a PLC network including a coordinator and a standby coordinator. The coordinator may perform scheduling coordination in a PLC cell and may periodically transmit scheduling information about the scheduling coordination to stations in the PLC cell. The standby coordinator may serve as a new coordinator instead of the coordinator when the coordinator does not operate for a predetermined amount of time.

The foregoing and/or other aspects and utilities of the present general inventive concept may also be achieved by providing a PLC method including designating stations to function as a coordinator and a standby coordinator among stations in a cell, performing scheduling coordination in the cell at the coordinator, periodically transmitting scheduling information about the scheduling coordination to the stations in the cell at the coordinator, and changing the standby coordinator to a new coordinator when the original coordinator does not operate for a predetermined amount of time.

The foregoing and/or other aspects and utilities of the present general inventive concept may also be achieved by providing a power line communication (PLC) network, including a coordinator to communicate with an external station in a PLC cell, and to designate the external station as a new coordinator according to a coordination capability thereof.

The coordinator may transmit a handover related message to the external station to request the external station to serve as the new coordinator, and may operate as a station in the PLC cell.

The handover message may include a medium access control header, a variable length command frame body, a block padding field, and a frame check sequence field.

The coordinator may receive a handover response message from the external station to operate as a station of the PLC cell.

The coordinator may also transmit a beacon to the external stations, and the beacon may include a beacon data unit ID, a length field, a new coordinator address, a new coordinator ID, and a new coordinator beacon number.

The coordinator may transmit a request message to the external station, the external station may include one or more stations to transmit information on coordination capabilities in response to the request message to the coordinator, and the coordinator may determine one of the one or more stations as the new coordinator according to the coordination capabilities of the one or more stations.

The foregoing and/or other aspects and utilities of the present general inventive concept may also be achieved by providing a power line communication (PLC) network, including a coordinator to communicate with external stations including a standby coordinator in a PLC cell, and to designate the external station as a new standby coordinator according to a coordination capability thereof.

The coordinator may transmit a request message and handover information message to the external stations and may receive response messages from the external stations, and each handover information message may comprise an ID field and a contention free slot body field having channel time allocation information.

The contention free slot body field may include ID fields of the respective external stations, a contention free slot request time unit field, a minimum number of TUs field, and a desired number of the TUs field.

The foregoing and/or other aspects and utilities of the present general inventive concept may also be achieved by providing a power line communications (PLC) network, including a station to communicate with an external coordinator in a PLC cell, to transmit information on the station to the external coordinator, and to serve one of a new coordinator according to a failure to receive a message from the external coordinator in response to the information, and a standby coordinator according to a coordination capability of the station in response to the information.

The foregoing and/or other aspects and utilities of the present general inventive concept may also be achieved by providing a power line communications (PLC) network, including a coordinator to communicate with external stations in a PLC cell, and to designate one of the external stations as one of a new coordinator and a standby coordinator according to coordination capabilities thereof, and one of the external stations to transmit information on the station to the coordinator, and to serve the one of the new coordinator according to a failure of receiving message from the coordinator in response to the information, and the standby coordinator according to the coordination capabilities in response to the information.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a power line communication (PLC) network according to an embodiment of the present general inventive concept;

FIG. 2 is a view illustrating the PLC network of FIG. 1 when standby coordination handover occurs;

FIG. 3 is a diagram illustrating a coordination handover method according to an embodiment of the present general inventive concept;

FIG. 4 is a diagram illustrating a coordination handover method according to another embodiment of the present general inventive concept;

FIG. 5 is a diagram illustrating a standby coordinator change method according to an embodiment of the present general inventive concept;

FIG. 6 is a view illustrating a basic frame structure of a handover related message used in a PLC method according to an embodiment of the present general inventive concept;

FIG. 7 is a view illustrating a command frame payload of a handover response message according to an embodiment of the present general inventive concept;

FIG. 8 is a view illustrating a command frame payload of a handover information message according to an embodiment of the present general inventive concept;

FIG. 9 is a view illustrating the structure of a contention free slot body (CFSB) according to an embodiment of the present general inventive concept; and

FIG. 10 is a view illustrating the structure of a handover information element according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

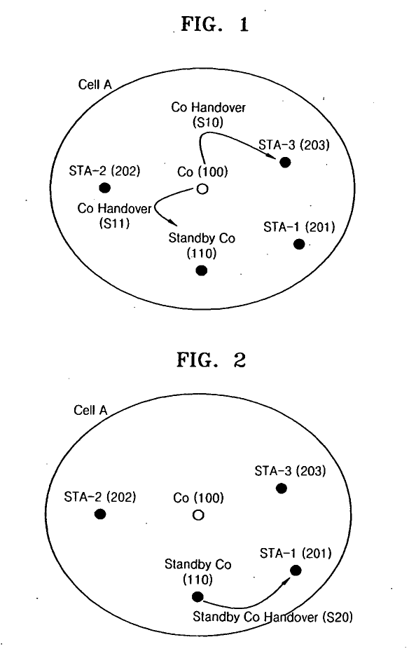

FIG. 1 illustrates a power line communication (PLC) network according to an embodiment of the present general inventive concept. Referring to FIG. 1, the PLC network includes devices or stations, such as a coordinator (Co) 100, a standby coordinator (standby Co) 110, and at least one station (STA-1 through STA-3) 201 through 203. The devices listed above form a cell in the PLC network.

The coordinator 100 performs scheduling coordination for medium access in a PLC cell. The coordinator 100 periodically transmits scheduling information about the scheduling coordination to the stations in the PLC cell by using a beacon message.

In the present embodiment, one of the stations in the PLC cell, not including the coordinator 100, is selected and designated as the standby coordinator 110. The standby coordinator 110 may operate as a general station.

However, if the coordinator 100 has a problem and thus can no longer serve as a coordinator, the standby coordinator 110 may operate as a new coordinator instead of the coordinator 100. Accordingly, the standby coordinator 110 becomes a coordinator to perform functions of the coordinator 100.

In the PLC network according to the present embodiment, if the coordinator 100 does not operate for a predetermined amount of time, the standby coordinator 110 becomes a coordinator.

Another station performing functions of the original coordinator 100 in lieu of the original coordinator 100 is referred to as coordination handover.

For example, if the coordinator 100 cannot operate for a predetermined amount of time, the coordination handover from the coordinator 100 to the standby coordinator 110 occurs as shown in operation S11 of FIG. 1.

Coordination handover from the coordinator 100 to a general station 203 may occur as shown in S10 of FIG. 1, due to a reason different from that resulting in operation S11.

In addition to the coordination handover, standby coordination handover may also occur. FIG. 2 illustrates the PLC network of FIG. 1 when the standby coordination handover occurs.

In FIG. 2, the standby coordination handover occurs from the standby coordinator 110 to a first station 201 as shown in S20.

A station having a best coordination or standby coordination performance may operate as a coordinator or a standby coordinator, respectively. However, coordination capabilities of stations in a cell may change over time.

Thus, in the PLC network according to the present general inventive concept, the coordination capabilities of the stations are compared and the coordination handover occurs from the current coordinator 100 to a station having a better coordination capability than the current coordinator 100.

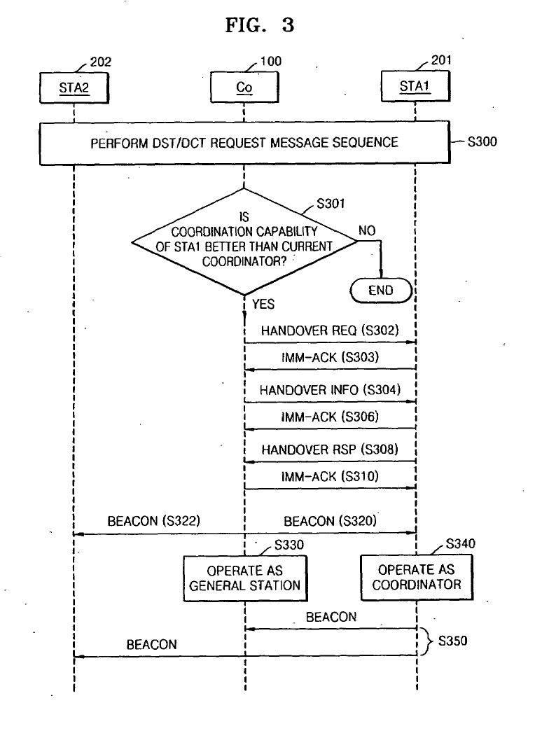

FIG. 3 is a diagram illustrating a coordination handover method of the PLC network of FIGS. 1 and 2 according to an embodiment of the present general inventive concept. Referring to FIGS. 1, 2, and 3, coordination handover occurs from the original coordinator 100 to the first station (STA-1) 201.

The coordinator 100 periodically requests and receives station information and performs DST/DCT request message sequence in operation S300. The station information takes the form of a detected cell table (DCT) and a detected station table (DST).

The coordinator 100 compares coordination capability of stations using the received station information in operation S301. If there is no station having better coordination capability than the coordinator 100, the current state is maintained and no coordination handover occurs. However, if there is a station (STA-1 in the case of FIG. 3) having a better coordination capability than the coordinator 100, the coordination handover occurs.

First, the current coordinator 100 transmits a handover request message to the first station 201 in operation S302. Upon receipt of the handover request message, the first station 201 transmits a receipt acknowledgement message Imm-ACK to the coordinator 100 in operation S303. In the following description, the receipt acknowledgement message will not be further denoted.

The coordinator 100 transmits handover information required to perform the coordination handover to the first station 201 in operation S304. The handover information includes information about a standby coordinator and channel time allocation information of each station.

The first station 201 notifies the coordinator 100 whether or not the coordination handover performed normally through a handover response in operation S308.

When the coordination handover is performed normally, the coordinator 100 transmits a beacon message to indicate that the coordination handover has been performed, and the first station 201 becomes a new coordinator to all the stations including the first station 201, in operations S320 and S322. In this case, the beacon message includes handover information elements (IEs) containing information about the new coordinator and an instant of time when a new beacon message transmits from the new-coordinator.

The coordinator 100 operates as a general station in operation S330.

The first station 201 operates as a coordinator in operation S340. The first station 201 transmits the beacon message, including the scheduling information, to the other stations in operation S350.

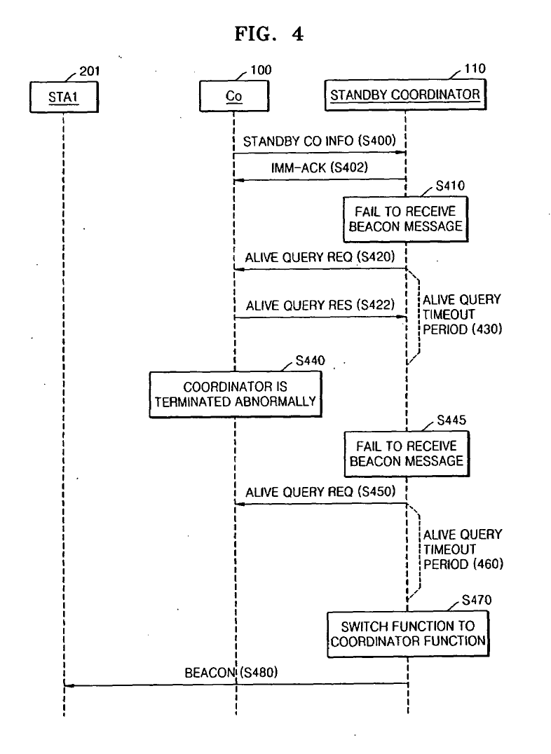

FIG. 4 is a diagram illustrating a coordination handover method of a PLC network according to another embodiment of the present general inventive concept. Referring to FIGS. 1, 2, and 4, the coordination handover occurs from the coordinator 100 to the previously designated standby coordinator 110.

When the coordinator 100 is designated as an initial coordinator or handed to a coordinator due to the coordination handover, it searches to find a station having a best coordination capability next to itself among stations in the PLC network. In FIG. 4, the station 110 has the best coordination capability next to the coordinator 100.

The coordinator 100 transmits required standby coordinator information to the station 110 in operation S400. Thus, the station 110 becomes a standby coordinator.

The coordinator 100 periodically transmits a beacon message to stations in the PLC network.

When the coordinator 100 operates normally, the standby coordinator 100 continuously checks the receipt of the beacon message.

If the coordinator 100 does not operate normally, a failure occurs in the receipt of the beacon message in operation S410. The standby coordinator 110 transmits an alive query request message to request a check of whether the coordinator 100 is “alive,” to the coordinator 100 in operation S420. The standby coordinator 110 sets a predetermined amount of time as an alive query timeout period for the coordinator 100, and awaits a response from the coordinator 100 for the set predetermined amount of time in operation S430.

If the standby coordinator 110 receives the alive query response message from the coordinator 100 before the alive query timeout period is terminated in operation S422, the coordinator 100 is capable to serve as the coordinator and thus, the coordinator 100 continues to serve as a coordinator.

If the coordinator 100 is terminated abnormally and thus cannot serve anymore as the coordinator in operation S440, the standby coordinator 110 fails to receive the beacon message in operation S445. The standby coordinator 110 transmits the alive query request message to the coordinator 100 in operation S450. However, if the standby coordinator 110 fails to receive the alive query response message from the coordinator 100 in operation S460 after a termination of the alive query timeout period, the standby coordinator 110 switches its function to a coordinator function in operation S470. Afterwards, the changed coordinator 110 transmits the beacon message to stations in the PLC network in operation S480.

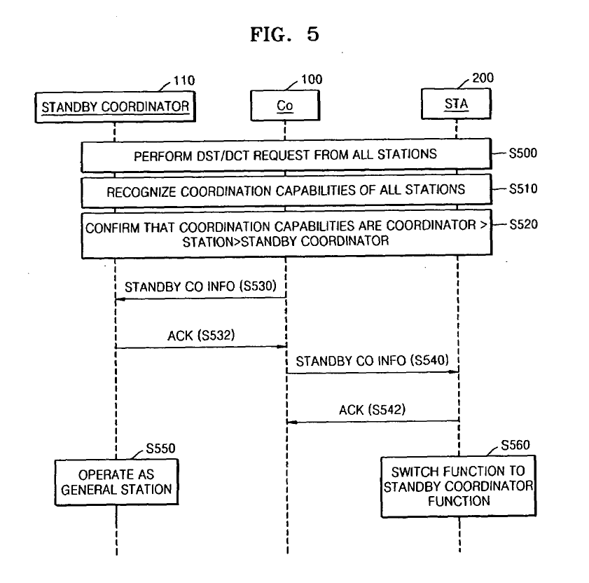

FIG. 5 is a diagram illustrating a standby coordinator change method according to an embodiment of the present general inventive concept.

Referring to FIGS. 1, 2, and 5, the coordination capability of stations in a PLC cell may change over time. If a station 200 has a better coordination capability than the standby coordinator 110, the station 200 becomes a new standby coordinator to replace the standby coordinator 110. At this time, standby coordination handover occurs from the standby coordinator 100 to the station 200.

The coordinator 100 collects station information from all the stations in the PLC network. The coordinator 100 transmits a station information request message to all the stations in the PLC network and receives response messages including the station information from the stations in operation S500.

The coordinator 100 recognizes coordination capabilities of the stations by comparing the station information of the stations in operation S510.

In operation S520 of FIG. 5, comparing the coordination capabilities allows the coordinator 100 to confirm that the coordinator 100 has the best coordination capability, followed by station 200, which is followed by the standby coordinator 110.

The following procedure performs the standby coordination handover.

The coordinator 100 transmits standby coordinator information, including standby coordination fail contents to disable the operation of a standby coordinator, to the current standby coordinator 110 in operation S530. Accordingly, the original standby coordinator 110 operates as a general station in operation S550.

The coordinator 100 transmits standby coordinator information, including standby coordination success contents to enable an operation of a new standby coordinator, to the station 200 in order to change the station 200 to the new standby coordinator in operation S540. The station 200 operates as the new standby coordinator in operation S560.

Hereinafter, the formats of messages used in a PLC method according to the present general inventive concept will be described.

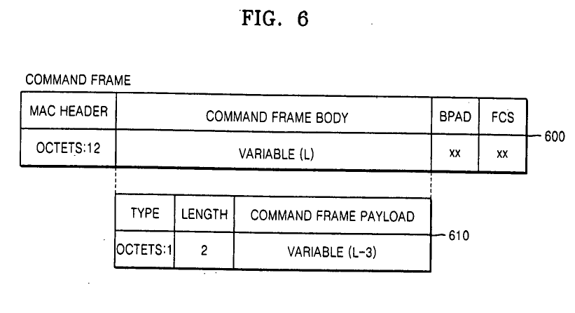

FIG. 6 illustrates a basic frame structure of a handover related message used in a PLC method according to an embodiment of the present general inventive concept.

Referring to FIG. 6, a basic command frame 600 of a handover related message according to an embodiment of the present general inventive concept includes a medium access control (MAC) header of 12 octets, a variable length command frame body 610, a block padding (BPAD) field, and a frame check sequence (FCS) field.

The command frame body 610 includes a type field of 1 octet, a length field of 2 octets, and a variable length command frame payload.

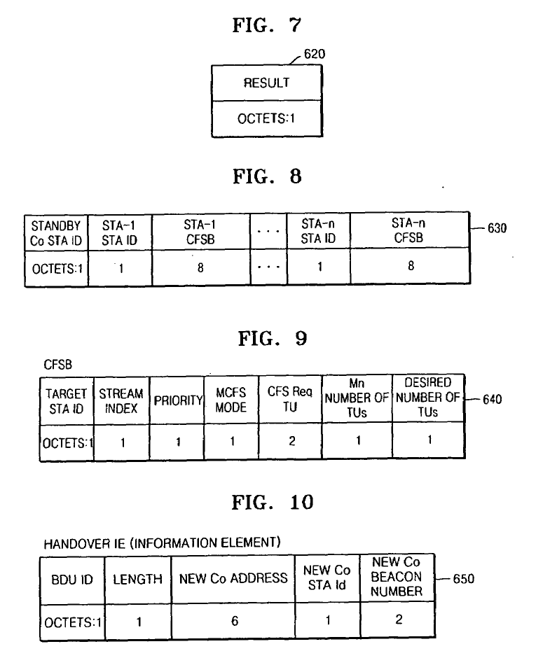

A handover response message and a handover information message to be described below take the form of the basic command frame 600 of FIG. 6, and their command frame payloads have forms as illustrated in FIGS. 7 and 8.

FIG. 7 illustrates a command frame payload 620 of the handover response message according to an embodiment of the present general inventive concept. Referring to FIG. 7, the command frame payload 620 includes a result field of 1 octet. The result field indicates whether the handover is performed normally.

FIG. 8 illustrates a command frame payload 630 of a handover information message according to an embodiment of the present general inventive concept. Referring to FIG. 8, the command frame payload 630 includes a standby coordinator station ID field of 1 octet, ID fields of 1 octet corresponding to each station, and contention free slot body (CFSB) fields of 8 octets corresponding to each station. The CFSB indicates channel time allocation information corresponding to each station.

FIG. 9 illustrates the structure of the CFSB field according to an embodiment of the present general inventive concept.

Referring to FIG. 9, the CFSB field includes a target station ID field of 1 octet, a stream index field of 1 octet, a priority field of 1 octet, a management contention free slot (MCFS) mode field of 1 octet, a contention free slot (CFS) request time unit (TU) field of 2 octets, a minimum number of TUs field of 1 octet, and a desired number of TUs field of 1 octet.

FIG. 10 illustrates a handover information element (IE 650) according to an embodiment of the present general inventive concept.

Referring to FIG. 10, the handover IE 650 included in the beacon of FIGS. 3-5 includes a beacon data unit (BDU) ID of 1 octet, a length field of 1 octet, a new coordinator address of 6 octets, a new coordinator ID of 1 octet, and a new coordinator beacon number of 2 octets. The handover IE 650 may be used to identify and label old and new coordinators in order to ensure the coordination handover methods of FIGS. 3 and 4 and the standby coordinator change method of FIG. 5 are successfully and accurately performed.

According to the present general inventive concept, if a problem occurs with a coordinator, coordination handover occurs from a coordinator to a standby coordinator, thereby providing a constant normal service to users. Specifically, coordination capabilities of stations are compared and a station having a best coordination capability serves as a coordinator, thereby offering the optimal cell scheduling. Therefore, the users can be provided with superior quality of service (QoS).

The present general inventive concept can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A power line communication (PLC) network comprising:
a coordinator to perform scheduling coordination in a PLC cell to periodically transmit scheduling information about the scheduling coordination to stations in the PLC cell; and
a standby coordinator to serve as a new coordinator instead of the coordinator when the coordinator does not operate for a predetermined amount of time.

2. The PLC network of claim 1, wherein:
the coordinator transmits the scheduling information by using a beacon message.

3. The PLC network of claim 2, wherein:
if the standby coordinator fails to receive the beacon message from the coordinator for a predetermined amount of time, the standby coordinator determines that the coordinator cannot operate and thus serves as the new coordinator instead of the coordinator.

4. The PLC network of claim 1, wherein:
one of the stations having a better coordination capability than the coordinator becomes the new coordinator.

5. The PLC network of claim of 4, wherein:
one of the stations having the best coordination capability next to the station that is changed to the coordinator is changed to a new standby coordinator.

6. A power line communication (PLC) method comprising:
designating stations to be a coordinator and a standby coordinator among stations in a cell;
at the coordinator, performing scheduling coordination in the cell;
at the coordinator, periodically transmitting scheduling information about the scheduling coordination to the stations in the cell; and
when the coordinator does not operate for a predetermined amount of time, changing the standby coordinator to a new coordinator.

7. The PLC method of claim 6, wherein the transmitting of the scheduling information at the coordinator comprises:
transmitting the scheduling information through a beacon message.

8. The PLC method of claim 7, wherein the change of the standby coordinator to the new coordinator comprises:
if the standby coordinator fails to receive the beacon message from the coordinator for a predetermined amount of time, transmitting a message to check if the coordinator operates from the standby coordinator to the coordinator; and
if the standby coordinator fails to receive the message confirming that the coordinator operates from the coordinator, determining that the coordinator does not operate.

9. The PLC method of claim 6, further comprising:
at the coordinator, receiving station information from the stations in the cell;
at the coordinator, comparing coordination capabilities of the stations using the station information; and
if there is one of the stations having a better coordination capability than the coordinator, changing the station having better coordination capability than the coordinator to the new coordinator.

10. The PLC method of claim 9, further comprising:
if there is another one of the stations having a coordination capability that is worse than the coordinator but better than the standby coordinator, changing the another station to a new standby coordinator.

11. The PLC method of claim 9, wherein the changing of the station to the new coordinator comprises:
transmitting a coordination handover request message requesting coordination handover from the coordinator to the station having the better coordination capability;
receiving a coordination handover response message from the station having the better coordination capability; and
transmitting a beacon message including information indicating that the station is to be changed to the new coordinator, information about the new coordinator, and information about an instant of time when the new coordinator transmits the beacon message, to the stations in the cell.

12. The PLC method of claim 10, wherein the changing of the station to the new standby coordinator comprises:
transmitting a message to disable an operation of the standby coordinator from the coordinator to the standby coordinator; and
transmitting a message to enable the operation of the standby coordinator from the coordinator to the station to be changed to the new standby coordinator.

13. A computer-readable recording medium having recorded thereon a program to implement a power line communication (PLC) method, the PLC method comprising:
designating stations to be a coordinator and a standby coordinator among stations in a cell;
at the coordinator, performing scheduling coordination in the cell;
at the coordinator, periodically transmitting scheduling information about the scheduling coordination to the stations in the cell; and
when the coordinator does not operate for a predetermined amount of time, changing the standby coordinator to a new coordinator.

14. A power line communication (PLC) network, comprising:
a coordinator to communicate with an external station in a PLC cell, and to designate the external station as a new coordinator according to a coordination capability thereof.

15. The PLC network of claim 14, wherein:
the coordinator transmits a handover related message to the external station to request the external station to serve as the new coordinator, and operates as one of stations in the PLC cell when the external station operates as the new coordinator.

16. The PLC network of claim 15, wherein the handover message comprises:
a medium access control header;
a variable length command frame body;
a block padding field; and
a frame check sequence field.

17. The PLC network of claim 15, wherein:
the coordinator receives a handover response message from the external station to operate as one of stations of the PLC cell.

18. The PLC network of claim 14, wherein:
the coordinator transmits a beacon to the external stations; and
the beacon comprises:
a beacon data unit ID,
a length field,
a new coordinator address,
a new coordinator ID, and
a new coordinator beacon number.

19. The PLC network of claim 14, wherein:
the coordinator transmits a request message to the external station;
the external station comprises one or more stations to transmit information on coordination capabilities in response to the request message to the coordinator; and
the coordinator determines one of the one or more stations as the new coordinator according to the coordination capabilities of the one or more stations.

20. A power line communication (PLC) network, comprising:
a coordinator to communicate with external stations including a standby coordinator in a PLC cell, and to designate one of the external stations as a new standby coordinator according to a coordination capability thereof.

21. The PLC network of claim 20, wherein:
the coordinator transmits a request message and handover information message to the external stations and receives response messages from the external stations, and each handover information message comprises an ID field and a contention free slot body field having channel time allocation information.

22. The PLC network of claim 21, wherein the contention free slot body field comprises:
ID fields of the respective external stations;
a contention free slot request time unit field;
a minimum number of TUs field; and
a desired number of the TUs field.

23. A power line communications (PLC) network, comprising:
a station to communicate with an external coordinator in a PLC cell, to transmit information on the station to the external coordinator, and to serve one of a new coordinator according to a failure to receive a message from the external coordinator in response to the information, and a standby coordinator according to a coordination capability of the station in response to the information.

24. A power line communications (PLC) network, comprising:
a coordinator to communicate with external stations in a PLC cell, and to designate one of the external stations as one of a new coordinator and a standby coordinator according to coordination capabilities thereof; and
one of the external stations to transmit information on the station to the coordinator, and to serve the one of the new coordinator according to a failure of receiving message from the coordinator in response to the information, and the standby coordinator according to the coordination capabilities in response to the information.
